(19) United States
(12) Patent Application Publication
(10) Pub. No.: US 2005/0258172 A1
(43) Pub. Date: Nov. 24, 2005

(54) Make-up processes and processes for application of a skin care product, and devices used in the implementation of such processes

(75) Inventor: Jean-Louis H. Gueret, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/123,173

(22) Filed: May 6, 2005

Related U.S. Application Data
(60) Provisional application No. 60/574,222, filed on May 26, 2004.

(30) Foreign Application Priority Data
May 6, 2004 (FR) 0404915

(51) Int. Cl. H05B 6/80

(52) U.S. Cl. 219/732

(57) ABSTRACT

A process for the application of a cosmetic product, such as a skin care product, incorporating particles of elongated shape such as fibers. The product can be stored in a packaging device. The process can include the steps of placing the packaging device in a microwave oven, raising the temperature of the product by exposing it to microwave radiation inside the oven, and applying the product with an applicator. Packaging devices for such a cosmetic product capable of being heated in a microwave oven are also disclosed.

### CROSS-REFERENCE TO RELATED APPLICATIONS

This document claims priority to French Application Number 04 04915, filed May 6, 2004 and U.S. Provisional Application No. 60/574,222, filed May 26, 2004, the entire contents of both of which are hereby incorporated by reference.

### BACKGROUND OF THE INVENTION

1. Field of the Invention

The present invention relates to make-up processes and processes for application of a skin care product, and also to the devices used in the implementation of such processes.

2. Discussion of Background

It has been proposed to apply cosmetic products after having raised their temperature. Thus, French patent application FR 2 376 401 proposes that shampoos be heated to a temperature slightly higher than that of the human body in order to achieve improved effectiveness. To this end, quantities of shampoo are placed in an apparatus incorporating heating elements. U.S. Pat. No. 5,775,344 describes a packaging and applicator device for mascara incorporating a heating element integral with the container.

International application WO 00/43286 describes a device incorporating components which, when mixed, produce an exothermic reaction enabling the temperature of a cosmetic composition to be raised.

Document DE-43,12,278 describes the preparation of a cosmetic composition by pre-heating the concentrated phase in a microwave oven before adding the water to be mixed with this concentrated phase in order to obtain the cosmetic composition.

### SUMMARY OF THE INVENTION

One object of the invention, according to a first embodiment, is a process for the application, for example on keratinic fibers, of a cosmetic product, such as a skin care product, incorporating particles of elongated shape such as fibers. This product can be stored in a packaging device. The process can include the following steps. The packaging device can be placed in a microwave oven. The temperature of the product can be raised by exposing it to microwave radiation inside an oven. The product can be applied with an applicator.

“Keratinic fibers” means any fiber composed mainly of keratin such as the hair, facial and body hair, eyelashes and eyebrows.

The expression “particles of elongated shape” includes in particular nonspherical particles having at least one axis of elongation, for example individually visible to the naked eye. It also includes fibers intended for example to lengthen the eyelashes and/or to produce aesthetic effects, in particular of color and/or shine. Flakes are another example of these particles of elongated shape. Micas and mother-of-pearl can also provide other examples of these particles of elongated shape.

“Fiber” is to be understood to mean an object of length L and diameter D such that L is much larger than D, D being the diameter of the circle within which the cross-section of the fiber is inscribed. In a preferred embodiment, the ratio L/D (or form factor) can be chosen in the range from 3.5 to 2,500, in particular from 5 to 500, and more particularly from 5 to 150. In particular, the fibers can have a length ranging from 1 μm to 10 mm, preferably from 0.1 mm to 5 mm, and even better from 0.3 mm to 3 mm. For example, the fibers can have a circular or polygonal cross-section.

The fibers can be present in the composition according to a preferred embodiment of the invention in a quantity ranging from 0.1 to 10% by weight, preferably from 0.5 to 5% by weight relative to the total weight of the composition.

The product can include fibers only, flakes only, or a mixture of the two. The product can include flakes in which one average larger dimension is between 50 μm and 1.5 mm for example. The product can include at least 0.2% by weight of these particles, for example fibers and/or flakes. The product can be intended to be applied to the eyelashes and/or eyebrows. The product can be a composition for coating keratinic fibers, such as a mascara. The particles can be dispersed in the composition.

The fibers can, for example, be chosen among rigid or non-rigid fibers. They can be of synthetic or natural origin, mineral or organic. By way of example, nonrigid fibers can include fibers of polyamide (Nylon), cellulose (or rayon), polyethylene. By way of example, rigid fibers can include polyimide-amide fibers such as those sold or poly-(p-phenylene-terephthalamide) (or aramide). It is also possible to use fibers of animal origin or vegetable origin such as cotton or flax fibers, or synthetic fibers, in particular those made from a thermoplastic polymer, or made of glass.

Preferably, the product is heated by exposing the packaging device to microwave radiation inside a microwave oven. Given that the nature of these particles differs from that of the product in which they are contained, their temperature may be raised more rapidly than that of the product. Thus, even if the packaging device is not exposed to microwave radiation long enough to render the product wholly fluid, the temperature rise in these particles fluidizes the product at least locally around each particle. When the product is applied using the applicator, the particles can then be oriented relative to the surface to which they are applied. If the particles are distributed evenly through the product, the product can then be heated and liquefied in a shorter time.

The term “microwave oven” means conventional ovens as used in other applications, for example, to heat food, and including a chamber in which an item to be heated can be exposed to electromagnetic energy.

Compared with heating by exposure to a source of infrared radiation, the use of a microwave oven enables a rapid increase in temperature to be achieved irrespective of the heat-conducting characteristics of the walls of the container holding the product.

The product can thus be brought quickly and easily to the desired temperature without having to incorporate a heating element into the packaging device. The temperature at the core of the product mass can be raised rapidly. The temperature rise of the product can progressively heat the walls of the container which are in contact therewith. The product can also be heated in a uniform manner by this type of radiation. Heating of the product can also be used to render the product homogeneous, repeatedly if desired. When the temperature rise is uniform, there is no separation of the chemical phases of the product.

Heating of the product can be used, for example, to facilitate spreading or retention on an area to be coated, for example the eyelashes, hair, skin or mucous membranes, or to improve the waving of hair. In particular, heating the product can improve its dermatological properties and/or improve its lengthening, curling, shining, matifying, softening, and or anti-wrinkle effects. Heating can be effective in the context of aromatherapy, to promote the effects of the aromas and the essential oils applied. Hot application of a cosmetic product can also simulate a sauna or hammam effect on the skin in the case of topical application. It can promote the penetration of an active ingredient of the product into the skin, mucous membranes or keratin fibers, and exert a local action on blood circulation, for example.

For example, the product may produce at least two types of effects depending on the temperature at which it is used. Advantageously, the product can possess properties which enable it to be applied either hot or cold, in particular at ambient temperature. For example, when applied cold, application of the product to keratinic fibers results in a heavier make-up finish, whereas hot application of this product to keratinic fibers produces a more extended make-up finish and improved sheathing of the fibers. This can enable the user to adapt the properties of a product to best suit the type of application, make-up or skin care desired.

For example, hot application of the product allows a thinner layer to be applied in order to obtain lighter coverage of make-up, and application of the same product at ambient temperature can be used to achieve a matifying effect. In effect, as the product is more fluid when hot, a larger surface area can be covered with a smaller quantity of product, hence the attenuated make-up finish that can be obtained when hot.

Similarly, just as a composition incorporating particles is rendered more fluid when hot than at ambient temperature, it becomes easier to achieve an even dispersion of these particles in the composition. Moreover, during application, the particles are more mobile in the composition and they can therefore be applied more evenly to the lashes, hair or skin.

When the product is a composition intended to cover keratinic fibers and has limited fluidity or a paste consistency at ambient temperature, “hot” application of this composition with an applicator, such as a brush or comb, to the keratinic fibers can promote the disposition of particles of elongated shape on these keratinic fibers. In effect, as the composition is more fluid by virtue of being heated, the particles of elongated shape are more readily oriented in the direction of the movement imparted thereto by the applicator. Particles having an axis of elongation can then be disposed along each of the lashes, thereby increasing their diameter and possibly extending their length.

The rheological properties of the product may be modified by temperature, in particular viscosity, surface tension, structural composition, and thixotropic properties, where appropriate. Heating can then facilitate take-up of the product. Heating of the products reduces their viscosity. They then spread more easily. Preferably, the composition is thermo-reversible, and after heating reverts to its initial properties that are more or less identical to those prior to heating.

For example, in the case of extemporaneous preparations including at least two components, for example two liquids or a powder and a liquid, for example extemporaneous hair care preparations, heating may accelerate mixing of the components and/or the dissolution of one component in another.

Heating can also be used to re-liquefy product which has dried on the walls of the container, and to cause it to flow into the bottom of the container to facilitate emptying. Heating by microwaves can provide bacterial purification, or pasteurization, of the product held in the container. This pasteurization can be carried out several times during the life of the product. This heating means that product formulations containing fewer preservatives can be envisaged.

Preferably, the product contains water or any other substance which absorbs the radiation emitted by microwave ovens and which heats up on exposure to microwaves.

An additional advantage associated with the use of microwaves to raise the temperature of the product lies in the possibility of incorporating thermal insulation permeable to microwaves into the packaging device, enabling heat to be retained by the product during use, and/or providing a holding surface cooler than the temperature of the product contained in the receptacle.

The product can be heated in the microwave oven in a manner such that its temperature is for example between 30° C. and 80° C.

The duration for which the product is exposed to microwave radiation can be between 1 and 60 seconds for example, preferably between 2 and 50 seconds, or between 3 and 25 seconds, being for example close to 5 seconds. Heating of the product can be divided into several heating stages with pauses in between. These pauses may allow the user to check the temperature reached by the product.

This duration depends in particular on the power of the oven, the nature of the container, the initial temperature and final temperature to be reached, and on the quantity and nature of the product to be heated. The device can include a table informing the user of the required heating time in relation to the power of the oven, for example.

The process can be put into effect once or several times, depending on whether or not the device is intended for single use.

The device may include a container having a shape making it possible to increase the exposure to microwave radiation. The container may in particular include a mark indicating to the user the position in which the container should preferentially be placed in the microwave oven. The container may for example be arranged so that the height of the product is lower in a heating position than in a normal usage position of the container. The height of the product is measured vertically between the lower level of the product and its upper level. The heating position may for example be a recumbent position to allow for the horizontal distribution of a microwave field in the oven chamber.

Alternatively, the heating position can be a raised position, achieved for example with a stand for the packaging device, so that the device is exposed to maximum radiation by being placed in a central zone of the oven space. The stand is placed for example on the oven bottom and by cooperation with the device enables the container to be raised relative to the oven bottom.

In the case of containers fitted with an applicator tip, in particular made of foam, or a wiper, these containers are preferably arranged so that the applicator tip and/or wiper are respectively heated by contact with the product heated at its core under the effect of the microwave radiation. The closed container can be placed “upside down” inside the microwave oven.

The applicator tip can be a comb for example obtained by injection moulding of a thermoplastic material, or a brush for example obtained by injection over-moulding onto bristles intended to form the application elements of the brush. The applicator tip can be composed of a flock material. Preferably, the applicator tip is made of a material capable of being heated in a microwave oven.

The container can include a wall arranged to allow it to be placed stably in a recumbent position, for example a wall having a prismatic transverse cross-section offering at least one flat surface rather than a circular transverse cross-section.

The packaging device may include a notice informing the user of the possibility of placing it in a microwave oven. This notice may for example consist of a form of words such as “microwave advanced technology”.

A further object of the invention, according to another of its aspects, independently or in conjunction with the foregoing, is a packaging device incorporating an applicator and a container holding a cosmetic product, including a skin care product, this product including particles of elongated shape, and the device being capable of being heated in a microwave oven. For example, the applicator is first detached from the container before the product is exposed to microwave radiation.

For example, the applicator can be kept out of the oven when the product is being raised to temperature, in particular when the applicator is incompatible with heating in a microwave oven. On the other hand, the applicator can also be placed in the microwave oven, in cases where this is made possible, with a view to exposing it to such radiation, for example in order to raise the surface temperature of the applicator, and in particular at its application surface.

Preferably the device includes at least one indicator intended to provide information on the temperature of the product.

The packaging device or an outer packaging for example can indicate the possibility of heating the packaging device in a microwave oven. An indicator of this kind can inform the user about the temperature of the product when it is removed from the microwave oven, to enable the product to be used properly at the desired temperature, and in particular to safeguard the user against being burned.

As the device is intended to allow the product to be heated in a microwave oven, it is preferably devoid of metal, for example metal components or metallic or electrically conductive coatings, preferably being made only of materials compatible with use in a microwave oven. After heating in the microwave oven, the outside temperature of the container is generally lower than the inside temperature of the product.

The indicator used may in particular serve to warn the user when the temperature of the product is higher than at least one pre-defined value. This indicator can be integral with the container holding the product. In the case where the device includes a closure element for the container, the indicator can be integral with this closure element. The device may also include an applicator and the indicator can then be integral with this applicator, and the indicator can thus be directly in contact with the product during the time that the device is placed in the microwave oven. In the case where the device includes a container with fitted base, the indicator can be integral with this base or can be held by it on the container. The base is for example snapped or welded onto the container. Where appropriate, the indicator can also be presented by the stand.

The temperature-sensitive indicator can be arranged in a variety of ways on the device. The indicator can be detachable or permanently fixed on the packaging device. Where the indicator is detachable, it takes the form for example of an elastomer ring incorporating thermochromic pigments capable of being slid onto and retained on an outer periphery of the container. The indicator can for example include at least one flexible support fixed, for example by gluing or welding, on the device. The indicator can for example take the form of a pad or an adhesive label affixed to a wall of the device, for example a wall of the container or a closure element of the container.

The indicator can also be made by printing or screen printing on the device using an ink incorporating a thermochromic pigment. The indicator can also be formed by incorporating a thermochromic pigment into the material of at least part of the device, for example the material of at least part of the container, at least part of a closure element of the container, at least part of a fitted base where applicable, or at least part of the applicator, for example at least part of an applicator element or rod connecting the applicator element to a handling element, which may serve where applicable to close the container.

The device incorporating such thermochromic pigments may for example be obtained by bi-injection. In this case, a viewing panel incorporating said pigments can be made in a wall of the container.

The indicator may include any material which changes its appearance with temperature, for example of cholesteric liquid crystals, possibly encapsulated, and preferably a material compatible with placement of the device in a microwave oven. For examples of materials which change their appearance according to temperature, reference may be made for example to patent application EP 1 191 317 A1 or U.S. Pat. No. 5,786,578.

The temperature sensitive indicator may for example change appearance, in particular its color, with temperature, by changing from one color to another when a pre-defined transition temperature is reached. The indicator can also present a transparency effect which is temperature-dependent, becoming transparent or opaque when a certain temperature is reached. Preferably, the indicator changes its appearance in a reversible manner with temperature, i.e., it reverts to its initial appearance when the device returns to its initial temperature. The indicator may also present a color saturation effect which is a function of temperature.

The indicator can be chosen in relation to its transition temperature and in relation to the thickness of the wall to which it is applied to take account, where applicable, of the thermal inertia, heat transfer coefficient, thermal resistance, and heat absorption coefficient of this wall. In this case, an indicator can be chosen such that the indication changes state at a temperature lower than the temperature to which it is desired to heat the product, to allow for the temperature difference which may exist between the product and the indicator when the latter is not directly in contact with the product but is separated from it by the wall of the container.

Two kinds of indications may be provided. A first indication can indicate that the temperature reached by the product is not dangerous, i.e., that it is lower than a first temperature Tmax or T1, for example in the order of 50° C. A second indication can indicate that the temperature of the product has effectively been raised by the heating process, and that it is in fact higher than a second temperature Thot or T2, for example in the order of 30° C., to ensure that product is applied “hot”. In this embodiment, when the temperature is between Thot and Tmax, the correct conditions are established for “hot” use of the product.

In a first embodiment, provision is made for the use of two separate indicators on the device, each of these indicators having a different transition temperature. A first indicator has a transition temperature to show when the temperature T1 has been exceeded, and a second indicator has a transition temperature to show when the temperature T2 has been passed. The chosen values for the transition temperatures can be for example several ° C. below T1 and T2 by reason of the thermal resistance of the walls between the indicator and the product.

In a second embodiment, provision is made for one temperature indicator placed on a wall of the device having at least two different thicknesses. Thus, by varying the thermal resistance of this wall, linked to its thickness, it is possible to have the same indicator change over in a first region, and remain unchanged in a second region. When the indicator has changed color only in the thin-wall region, and the thick-wall region of the same indicator remains unchanged, the user can then pick up the container and apply the product. Preferably the regions where the wall is thicker serve as the grasping surfaces as they are cooler. In this case, to ensure that the indicator is reliable, the thickness of the wall of the container, at the point where the indicator is attached, is preferably controlled precisely.

To obtain such a container having a variable wall thickness, horizontal, vertical or helical ribs can project beyond an external outline of the container. Alternatively or in addition, the container can present a circular inner outline on a transverse cross-section, whereas its external outline may be of any shape except that of a similar circular form of which the centre is superimposed on that of the inner outline. For example, the external outline, on this same transverse cross-section, can take the form of an excentric circle, ovoid, triangle, rectangle, or any type of polygon.

The device can also include an applicator for the product held in the container. This applicator may or may not be exposed to microwave radiation. Where the applicator cannot be heated in this way, it can be placed in a holder during the time that the container is exposed to microwave radiation. For example, this holder can be attached to the container in a storage position during periods when the container is not being heated.

This applicator is preferably integral with a plug enabling the container to be closed. The applicator can be made by moulding in a single piece with the plug, or can be fitted thereon and held in place by over-moulding or gluing.

The device can include at least one safety valve to avoid excessive pressure build-up inside the device if the latter is inadvertently exposed to microwave radiation for too long a period.

The device may also include an anti-splash element to reduce the risk of product being expelled when the device is opened, under the effect of excess pressure created by heating the product, caused for example by the expansion of air. An element of this kind may or may not be actuated by the user before opening. Thus, in one embodiment, the anti-splash element includes a part on which the user can press to balance the pressure between the inside and the outside of the container, before opening the container.

As a variant, the anti-splash element automatically performs its function when the container is opened or when the applicator is withdrawn. This anti-splash element can also in particular serve to wipe the applicator. In a further variant, it is the applicator itself that can be used to reduce the risk of expulsion of product on opening, for example by forming a barrier against possible splashing of the product.

The device can also include a flow-reducing element serving for example to reduce the risk of loss of product in case the container is accidentally overturned, in particular if the fluidity of the product has greatly increased with temperature.

A further object of the invention, independently or in combination with the foregoing, is a method for promoting the sale of a packaging device containing a cosmetic product, including a body care product, excluding depilatory waxes, for which the device can be placed in a microwave oven to raise the temperature of the product in order for example to modify the properties of the latter, in particular its rheology. This product is for example a body care or make-up product such as a foundation or a mascara.

A further object of the invention, independently or in combination with the foregoing, is a method for promoting the sale of a packaging and application device containing a cosmetic product, which makes known the possibility of obtaining two different make-up effects according to whether the product is used hot or cold.

Promotion of the product can be effected through any channel of communication. This may be done by a vendor, directly at the point of sale, or via radio or television, in particular in the context of advertising commercials. It may also be done through press publications or by means of any other document, in particular for advertising purposes. It may also be done through a computer network or mobile telephone network. It may also be done on the packaging device, other packaging media or in accompanying instructions.

A further object of the invention, according to another of its embodiments, independently or in combination with the foregoing, is a packaging device for a cosmetic product including: a container having a wall made at least partially in a first material, a thermal insulator defining at least partially the external surface of the container, this thermal insulator being for example made in a second material having a thermal conductivity lower than that of the first material, a cosmetic product, including a body care product, held in the container.

A further object of the invention according to one embodiment is the use of such a device in a process including, for example, the following steps: raise the temperature of the product preferably by placing it in a microwave oven, apply the product with an applicator.

A further object of the invention according to one embodiment, independently or in combination with the foregoing, is a device including, for example: a container, a cosmetic product, including a body care product, held in the container, an applicator equipped with an applicator element, a wiper element arranged to wipe the applicator element as it leaves the container, the applicator and wiper element being intended to allow the air to escape on opening the device in case of excess pressure in the container.

A further object of the invention according to an embodiment is the use of such a device in a process including the following steps: raise the temperature of the product preferably by placing it in a microwave oven, apply the product.

A further object of the invention according to another embodiment is the utilization of a device including: a container, a cosmetic product held in the container, an applicator incorporating at least one part made in a material having a heat capacity enabling it to store heat, in a process including the following steps: raise the temperature of the product preferably by placing it in a microwave oven, apply the product.

The desired heat capacity can be obtained for example by using a ceramic or a plastic material incorporating a high percentage, for example greater than or equal to 60% by weight, of a charge, for example mineral, in particular metallic or a ceramic or a porous structure capable of taking up the product within its depth, the latter then storing the heat.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The invention will be better understood from the following detailed description of non-limitative embodiments of the invention, and by reference to the attached drawings in which:

FIG. 1 is a block diagram showing the stages of an example of the process according to an embodiment of the invention;

FIGS. 2 to 10 illustrate different possible embodiments, inter alia, of the temperature sensitive indicator;

FIGS. 11 to 15 show different possible embodiments of thermal insulation on the container;

FIG. 16 is an embodiment of an anti-splash element allowing excess pressure to escape;

FIG. 17 shows a bottom view in isolation of the anti-splash element on arrow XVII in FIG. 16;

FIGS. 18 and 19 show other examples of devices that enable excess pressure to escape;

FIG. 20 shows a partial view in elevation of an example of a rotary applicator;

FIG. 21 shows a partial view in elevation of an example of a device including a foam applicator integral with the container;

FIG. 22 is a schematic and partial view in longitudinal section of an example of a device including an applicator element integral with a closure element for the container;

FIG. 23 shows an over-moulded bristle in isolation;

FIG. 24 shows an example of an applicator made in a material having a high heat capacity;

FIG. 25 is a schematic illustration of a device intended to curl the eyelashes and incorporating a heating element;

FIG. 26 illustrates an embodiment of a container having a shape offering a stable recumbent position;

FIGS. 27 and 28 are partial schematic illustrations of containers equipped with active safety means in case of excess pressure in the container;

FIG. 29 is a sectional longitudinal view of a device according to an embodiment of the invention wherein the receptacle includes a side wall 41 of variable lengthwise thickness;

FIGS. 30a, 30b and 30c are partial schematic illustrations of containers for the device according to an embodiment of the invention provided with lengthwise, transverse and helical ribs respectively on their external outline, locally modifying the thickness of the side wall 41;

FIGS. 31a to 31f show transverse sectional views of containers for the device according to an embodiment of the invention, wherein the thickness of the side wall 41 of the container can be variable on the external outline in this sectional plane;

FIG. 32 shows a transverse sectional view of a container for a device according to an embodiment of the invention including a side wall 41 having lengthwise ribs of variable width, these ribs extending radially relative to an inner circular outline of the receptacle;

FIG. 33 shows a device according to an embodiment of the invention wherein the indicator is presented in the form of a ring 400 slid onto and retained on a substantially cylindrical exterior outline of the receptacle 41;

FIG. 34 shows a device according to an embodiment of the invention wherein the indicator 401 is presented in the form of a U encircling at least partially the external outline of the device, the free ends of this U bearing against a plane along which the device is laid. Thus the U indicator also serves to immobilize the device, which in this instance is substantially cylindrical in shape, in a recumbent position relative to the surface;

FIG. 35 illustrates a device according to an embodiment of the invention wherein the indicator is presented in the form of a clip 402 including a first portion intended to be clipped around the external outline of the device, and a second portion intended to bear against a surface parallel to which the device is laid. This clip type indicator thus serves to immobilize the device, which in this instance is substantially cylindrical in shape, in a recumbent position relative to the surface, and also serves to raise the device relative to this surface;

FIG. 36 shows a longitudinal sectional view of a device according to an embodiment of the invention incorporating a fitted base 403 and an applicator mounted in a cap to close the receptacle. The fitted base is mounted on the container in a leaktight manner, with a snap-on attachment, but also so as to hold at least one indicator 404, in this instance two toroidal indicators 404 and 405 held between the base 403 and the receptacle 41;

FIG. 37 shows a longitudinal sectional view of a receptacle 41 for a device according to an embodiment of the invention, this receptacle including a screw-in fitted base 406, wherein the base is made of a material incorporating thermochromic pigments capable of serving as an indicator;

FIG. 38 shows a longitudinal sectional view of a device according to an embodiment of the invention incorporating a fitted base 407 and an applicator mounted in a cap to close the receptacle. The fitted base is mounted on the container 41 in a leaktight manner, by screwing, the base being bi-injected so as to present at least one portion 408 forming the temperature indicator, preferably visible from the external surface of the base;

FIG. 39 shows a view of a device according to an embodiment of the invention incorporating a viewing panel 409 through which the product P including particles of elongated shape F contained in the receptacle can be seen; and

FIGS. 40a, 40b and 40c show three successive stages in the process according to an embodiment of the invention wherein a container M intended to be heated in a microwave oven is first detached from another holder S which receives the applicator A during the time that the receptacle is being heated, this applicator A being equally capable of mounting either on the container M or the holder S. Once the container M has been heated in the microwave oven, FIG. 40b, the applicator A is detached from the holder S in order to take up a quantity of heated product from the container M. When not in use, as shown in FIG. 40a, the container M can be made integral with the holder S in which the applicator A is stowed.

FIG. 41 shows a diagrammatic view of a chamber 300 of a microwave oven inside which is placed a device 301 according to an embodiment of the invention, this device containing a cosmetic product and being capable of being heated in an oven of this kind. For example, the chamber 300 is equipped with a turntable 302 on which is placed the device 301. Preferably, the device 301 is placed at the centre of the turntable 302. In the embodiment shown, the device 301 is raised relative to the turntable 302 by means of a stand 303. The stand 303 allows the container 304 of this device 301 to be placed higher than the surface formed by the turntable 302. Thus, the container 304 can be placed in a central region of the chamber 300, in which the microwave radiation is more intense.

FIG. 42 shows a stand 303 according to a particular embodiment of the invention. The stand 303 takes the form of a sleeve incorporating a stud 306 on its inner wall 305. For example, it includes several such studs 306. This sleeve engages with a screw thread 307 provided in this instance around the outer periphery of the container 304. For example, a means of closure 308 of the device 301 projects beyond the sleeve irrespective of the extent to which the stud 306 is engaged with the screw thread 307. Thus the user can easily set the device 301 in a high position relative to the stand 303 when they are placed in the oven. Alternatively, the stud can be provided on the outer periphery of the container 304 while the inner wall 305 of the sleeve offers a counterpart screw thread.

FIG. 43 shows the stand 303 according to another particular embodiment of the invention. The stand 303 takes the form of a perforated sleeve which can be moved along the container 304.

FIG. 44 shows the stand 303 according to another particular embodiment of the invention. The stand 303 takes the form of a pivoting means about an axis orthogonal to a principal axis of elongation X of the device 301. In particular, the pivot is made at the level of the container 304. For example, the stand 303 can be used to place the device in an elongated and raised position relative to the surface of the turntable 302. The axis X is then parallel to this surface. As a variant, the pivoting means can hold the axis X orthogonal to the surface of the turntable 302, while at the same time allowing the receptacle to be raised relative to this surface.

### DETAILED DESCRIPTION OF THE PREFERRED EMBODIMENTS

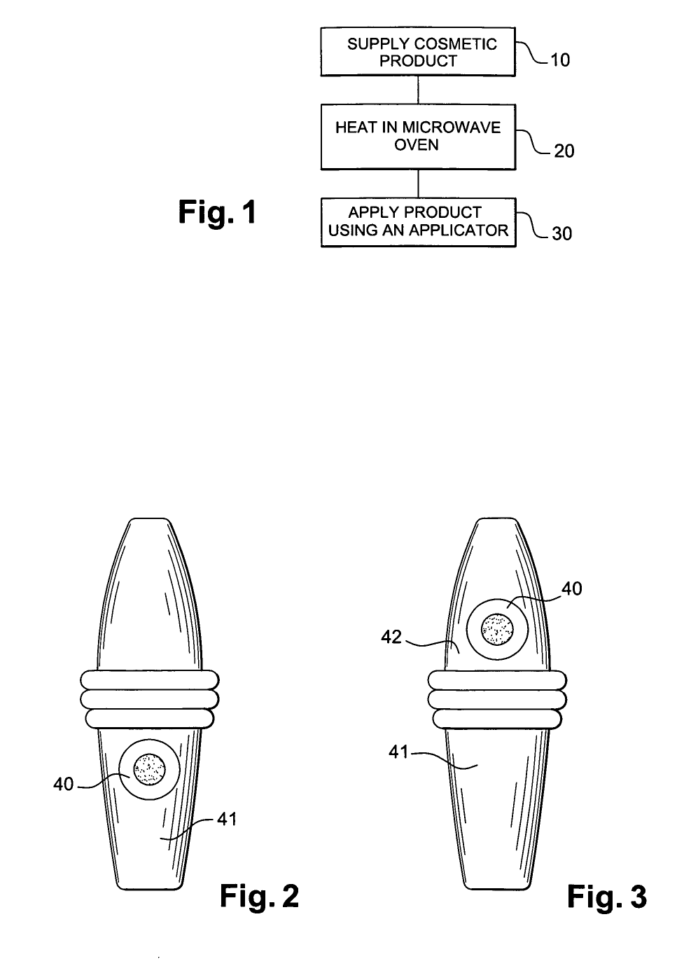

The block diagram in FIG. 1 illustrates different stages in a process that can be used to raise the temperature of a cosmetic product according to a first aspect of the invention.

This process includes a first stage 10 involving the supply of the cosmetic product in a packaging device, possibly fitted with an applicator. The cosmetic product can be supplied via any mode of sale, in particular by sale in a shop or by mail order, or through a beauty establishment or hairdressing salon, for example.

The process then includes a stage 20 which involves heating the product in a microwave oven. The packaging device is suitable for placement in the microwave oven and preferably does not include any metallic or electrically conductive element liable to be damaged during exposure to microwave radiation or to damage the oven used.

The emissive power of the microwave radiation and the duration of exposure of the product to this radiation can be selected in relation to the target temperature to be reached and to the contents of the packaging device. Preferably, the power of the microwave oven is selected so that the time for which the product is exposed to the microwave radiation is relatively short, for example less than 20 seconds, in particular in the order of several seconds.

The packaging device is then taken out of the microwave oven and stage 30 is carried out, involving application of the product. This application can be accomplished for example with an applicator which can be detachably mounted on the container holding the product when the latter has been placed in the microwave oven or separate from the packaging device. Application can also be accomplished using a finger, for example.

The product P may for example be a lip color, a mascara, a foundation or a skin care product, without this list being limitative. The product P includes particles F of elongated shape dispersed in the product P.

A product preferentially intended to be heated is a composition capable of covering keratinic fibers.

For example, a product according to an embodiment of the invention has the following composition:

| | | |
|---|---|---|
| Beeswax | 6.00% | |
| Paraffin wax | 13.00% | |
| Hydrogenated jojoba oil | 2.00% | |
| Hydroxyethyl cellulose | 3.00% | |
| Triethanolamine stearate | 8.00% | |
| Black pigment | 5.00% | |
| Nylon ® fibers | 2.50% | |
| Preservative | qs | |
| Water | qsp | 100.00% |

At ambient temperature, i.e., at 20° C., the product can exhibit properties, in particular rheological properties, which allow application at this temperature, in particular that of being liquid at ambient temperature, as well as other properties which also allow application when the temperature is higher, for example above 30° C.

At the end of the heating period in the microwave oven, the temperature of the product inside the packaging device may exceed 50° C., or 70° C. Advantageously, the packaging device can be equipped with a temperature sensitive indicator, for example an indicator which changes its appearance, such as its color, with temperature. This indicator can for example take the form of a label or pad 40 glued onto the side wall 41 of the container, as illustrated in FIG. 2, or glued to a closure element 42 of the container, as illustrated in FIG. 3. The closure element 42 may possibly constitute the grasping element of an applicator of which the application element is held inside the container when the latter is closed.

The temperature indicator can also be made by blending a thermochromic pigment with the material intended for example to form the upper part 45 of the container. In the example in FIG. 5, the temperature indicator takes the form of a strip 47 made for example by bi-injection or co-extrusion with the wall of the container body, for example in a material which changes color according to temperature. This strip can serve as a viewing panel if it is made in a material that is transparent at least at certain temperatures.

Screen printing may also be used to affix, for example on the side wall 41 of the container, a strip 46 as illustrated in FIG. 6 or any other motif using an ink incorporating a thermochromic pigment.

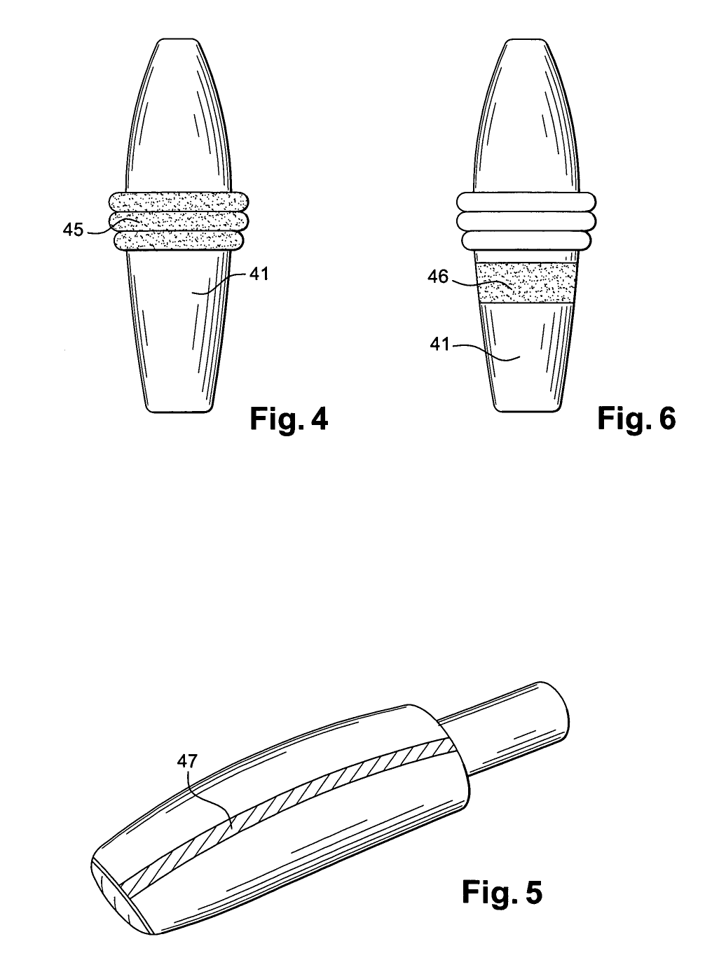

In the examples shown in FIGS. 2 to 6, the indicator is visible from the outside. The scope of the invention is not exceeded when the indicator is not visible from the outside when the container is closed but becomes visible at the time of application or when the user performs a particular action, for example by withdrawing the indicator from the container.

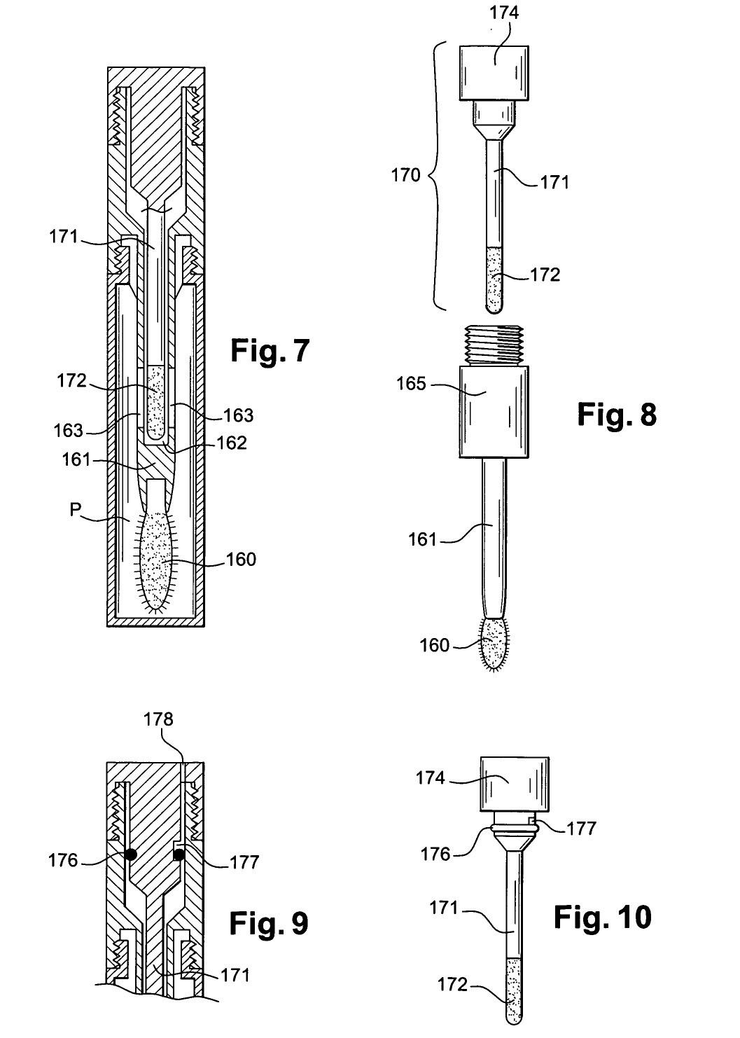

FIGS. 7 and 8 illustrate a device having a container holding the product P and an applicator incorporating an applicator element 160 attached to the end of a rod 161 including a seating 162 into which a temperature indicator 170 can be inserted. The latter includes a rod 171 of which the end 172 changes color for example according to temperature. Openings 163 may be made in the rod 161 if required to allow the product P to come into contact with the temperature indicator 170. In the example considered, the rod 171 is connected at its upper extremity to a threaded part 174 which can be screwed onto the grasping element 165 of the applicator.

Where appropriate, as illustrated in FIGS. 9 and 10, the temperature indicator can be attached to the device in a manner such that it also serves as a safety valve in case of excess pressure in the container.

The rod 171 of the temperature indicator can for example have an O-ring seal 176 which in the absence of overpressure provides a leaktight closure. An indentation 177 is provided in the rod 171 and in case of overpressure the O-ring seal 176 deforms locally by pushing up into this indentation 177, which allows the air under pressure to escape.

An aperture 178 can be made, where appropriate, in the upper part 178 of the temperature indicator to provide an outlet for the air.

The temperature indicator can be made by any known means, in particular using any known thermochromic pigment or any other material which changes color with temperature and preferably compatible with placement of the packaging device in a microwave oven to heat the product.

According to another aspect of the invention, the packaging device can include a thermal insulator 50, as illustrated in FIG. 11, which can cover for example a part of the side wall 41 of the container holding the product. This insulator 50 can for example take the form of a sleeve made of a material less thermally conductive than that used to make the side wall 41 of the container, this sleeve being fixed in an annular groove on the container. Such an insulator 50 allows the container to be grasped more comfortably when the latter is removed from the microwave oven and when the temperature of the product is in the region of 70° C. for example.

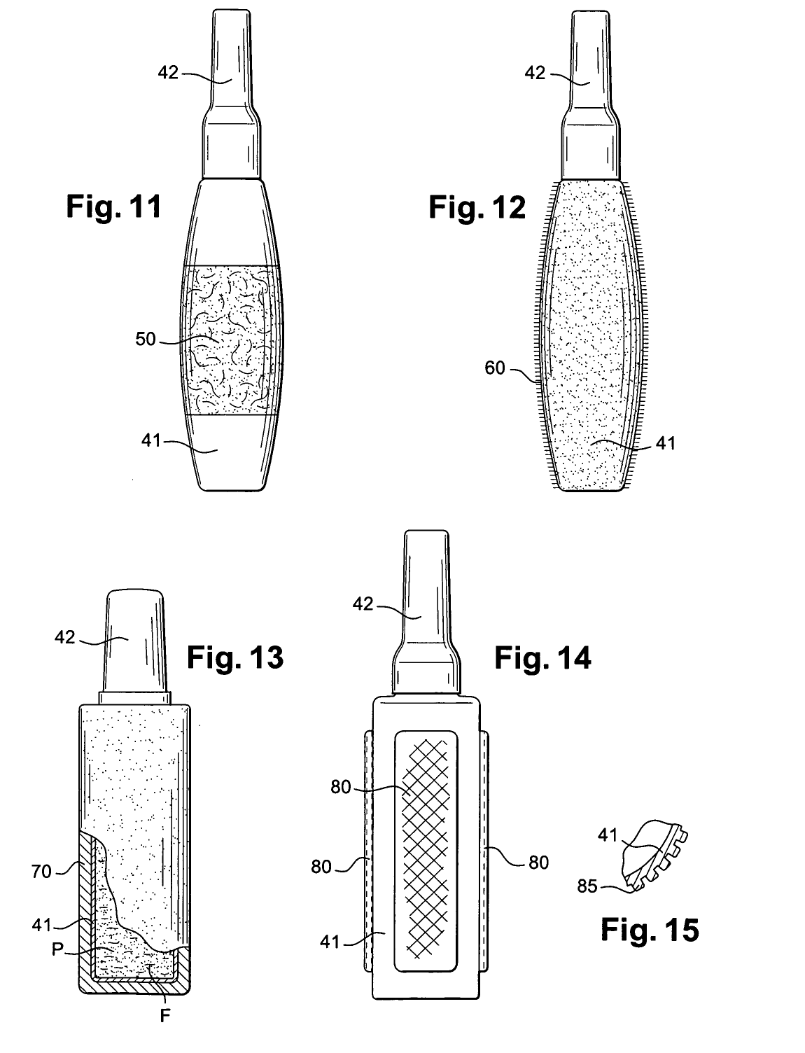

The insulator 50 can be made for example of a polyurethane or polyethylene foam. The insulator can also be made differently, for example in the form of a flock coating 60 covering at least part of the side wall 41 of the container, as illustrated in FIG. 12. The insulator can also be made in the form of a casing 70, as shown in FIG. 13, this casing 70 having for example the general shape of a glove finger allowing the container to be inserted. The insulator can also be made in the form of strips 80 or other elements attached, for example by gluing, to the side wall 41 of the container, as illustrated in FIG. 14. The container can also be made for example with fins 85, as illustrated in FIG. 15.

According to another aspect of the invention, the packaging device can be configured to allow the excess air pressure created inside the container by heating the product to escape when the container is opened, at the same time limiting the risk of splashing or leakage of the product.

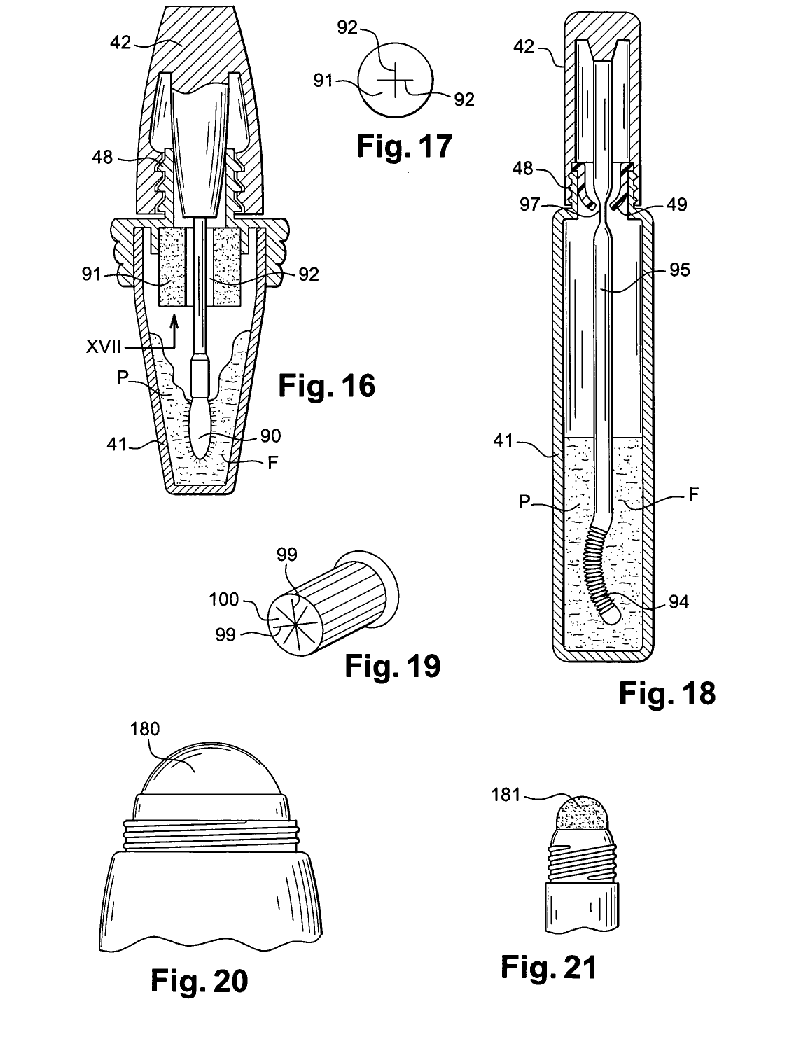

When the device is also used to apply the product and includes, as illustrated in FIG. 16, an applicator including an applicator element 90 and a wiper element 91 to strip the applicator element as it leaves the container, the wiper element 91 is advantageously intended so as to allow any overpressure present inside the container after heating the product P to escape gradually when the container is opened.

The wiper element 91 can for example take the form of a block of foam incorporating a passage for the applicator element 90, this passage having at least one slot and for example two slots 92 in the example illustrated in FIG. 17. These slots 92 allow air under pressure to escape when the closure element 42 is unscrewed sufficiently from the neck 48 of the container, thereby limiting the risk of splashing of the product.

It is seen in FIG. 17 that the applicator element can take the form of a flock applicator, this applicator for example including an elastomer or plastic body with its surface covered in a flock coating. The applicator need not include a flock covering. Thus the applicator can be made for example by moulding a plastic into a particular shape, in particular a shape enabling the eyelashes or eyebrows to be combed.

FIG. 18 illustrates an applicator element 94 forming a comb, the latter being fixed at one end of a rod 95 connected to a grasping element which also constitutes a closure element 42 of the container.

In the example considered, the wiper and anti-splash element takes the form of an elastomer component mounted in the neck 48 of the container and provided at its lower end with a wiping lip 49 defining an opening, for example circular.

The rod 95 can include a groove 97 enabling air under pressure to escape when the container is opened. This groove 97 may be annular or may extend over only part of the circumference of the rod.

The wiper element can also be made with a plurality of radial slots 99, as illustrated in FIG. 19, these slots defining between them sectors 100 capable of deforming under the pressure of the air inside the container thereby allowing it to escape. Various other means can also be used to reduce the risk of splashing of the product in case of overpressure in the container.

FIG. 20 partially illustrates a device in which the applicator includes a rotary applicator element such as a ball 180 for example. This ball 180 enables the product to be applied while at the same time reducing the risk of splashing of the product when the closure cap, not shown, is removed.

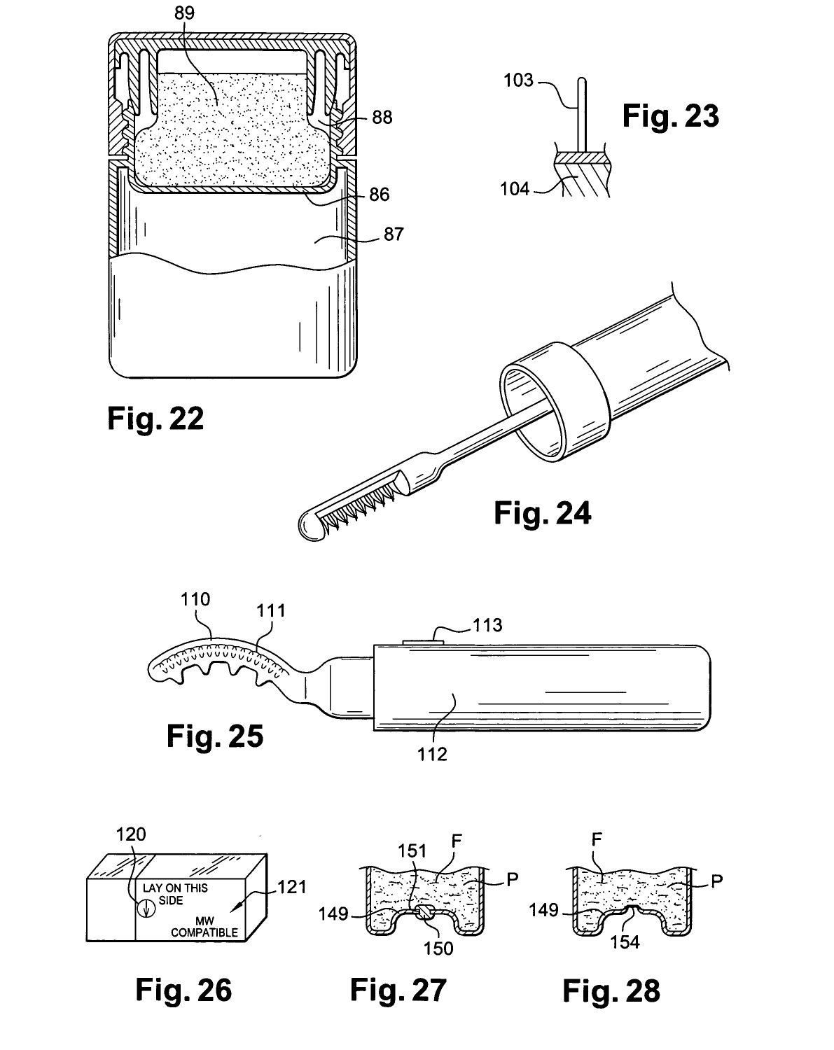

The rotary applicator element can be replaced, for example, by a non-rotary applicator element permanently fixed on the container, such as a foam applicator 181 as illustrated in FIG. 21. Provision can also be made for a perforated wall 86, for example between a space 87 in the container holding the product and an opening 88 through which the product is taken up, as illustrated in FIG. 22. Where appropriate, this wall 86 can serve as the seating for an applicator element 89.

Generally speaking, when microwave radiation is used to raise the temperature of the product P, the packaging device is preferably devoid of metallic elements and the applicator is preferably made without metal. Thus, where it is desired to use a brush, the latter can be made with bristles 103 over-moulded on a support 104, as illustrated in FIG. 23, the bristles and support being for example made of different thermoplastic materials.

According to another aspect of the invention, the applicator element can be made in such a way that it possesses a sufficiently high thermal inertia that the product present on the applicator element does not cool down too quickly. It is thus possible to make the applicator element, such as for example a comb as illustrated in FIG. 24, in a plastic material incorporating a large proportion of a mineral or other charge imparting to it an elevated heat capacity.

The applicator element can thus be made by moulding a thermoplastic or thermo-hardening material incorporating a charge of a compound such as bronze or an aluminum oxide. It is in particular possible to make the applicator element by moulding a mixture incorporating 60% by weight of aluminum oxide and the remainder of polyamide or polypropylene. By way of a further non-limitative example, the applicator element can also be made by moulding a mixture incorporating 40% by weight of polypropylene and 60% of a ceramic.

FIG. 25 shows a device used to curl the eyelashes, incorporating an element 110 with an elevated heat capacity, intended to be brought into contact with the eyelashes for the purpose of imparting a curl to them, incorporating a heating element 111, which is connected by an electrical circuit (not shown) to an electrical power source contained in a handle 112, and a switch 113 enabling the element 111 to be energized. This device can include a thermostat system enabling the current to be interrupted when the element 110 reaches a sufficient temperature. This applicator device is detached from the receptacle and is not exposed to microwave radiation. It is used in addition to heating of the product.

The fact that the thermal inertia of the element 110 is relatively large, by virtue of the use of a charged plastic for example, can make it possible to reduce the power consumption of the device. The thermal inertia of the applicator element can also be increased by using a material to make the applicator that is capable of becoming internally loaded with the product to be applied, for example a porous material such as a foam or an agglomerate.

In addition, the container can advantageously be made with a shape enabling it to be laid flat without rolling in the microwave oven, in order to derive most benefit from the distribution field of the microwaves in the oven. By way of example, FIG. 26 illustrates a container of square transverse cross-section, capable of being laid on one of its sides. It can be seen in this figure that the container can include, for example, a reference mark 120 indicating to the user the most suitable way of placing the container in the microwave oven. The container may also include a notice 121 indicating the possibility of placing the device in a microwave oven.

To allow the product and air to escape in the event that the device is accidentally left too long in the microwave oven while it is in operation, a safety valve can be provided on the container. By way of example, FIG. 27 shows a partial axial cross-section of a container in which the bottom 149 is provided with a closure 150 forming a safety valve. This closure 150 is formed for example by an elastomer plug fixed in a hole 151 in the bottom wall 149 and capable of being expelled in case of excess pressure in the container. As a variant, the safety valve can be made by a constriction 154 in the bottom wall, as illustrated in FIG. 28. In case of overpressure, the wall is able to breach at the constriction.

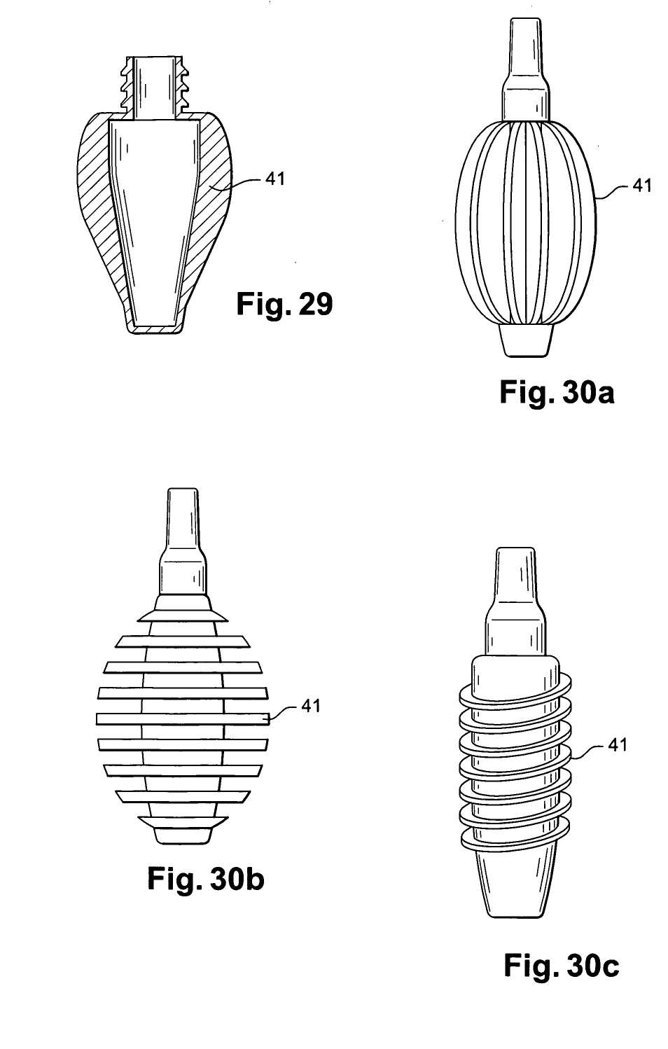

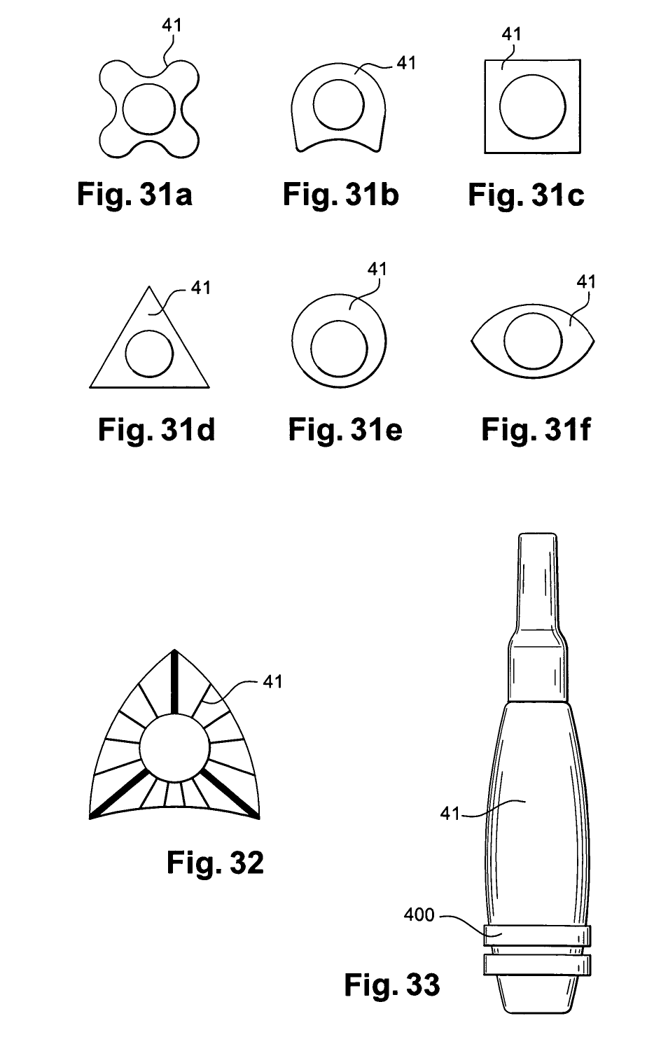

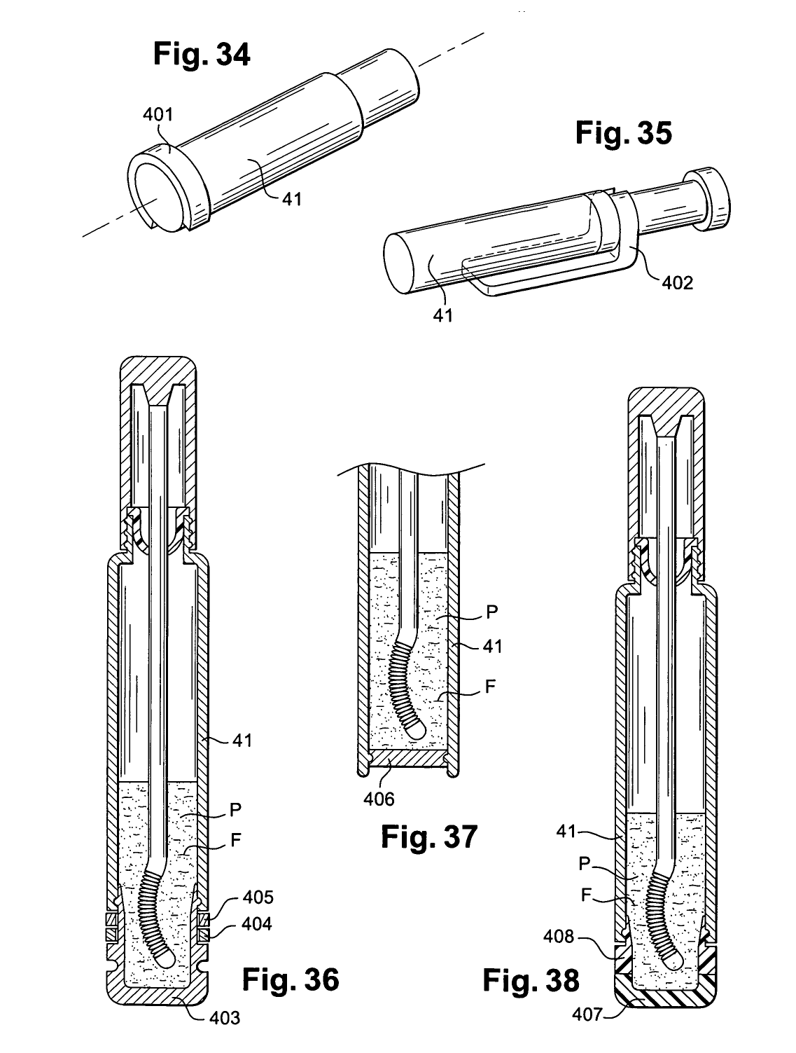

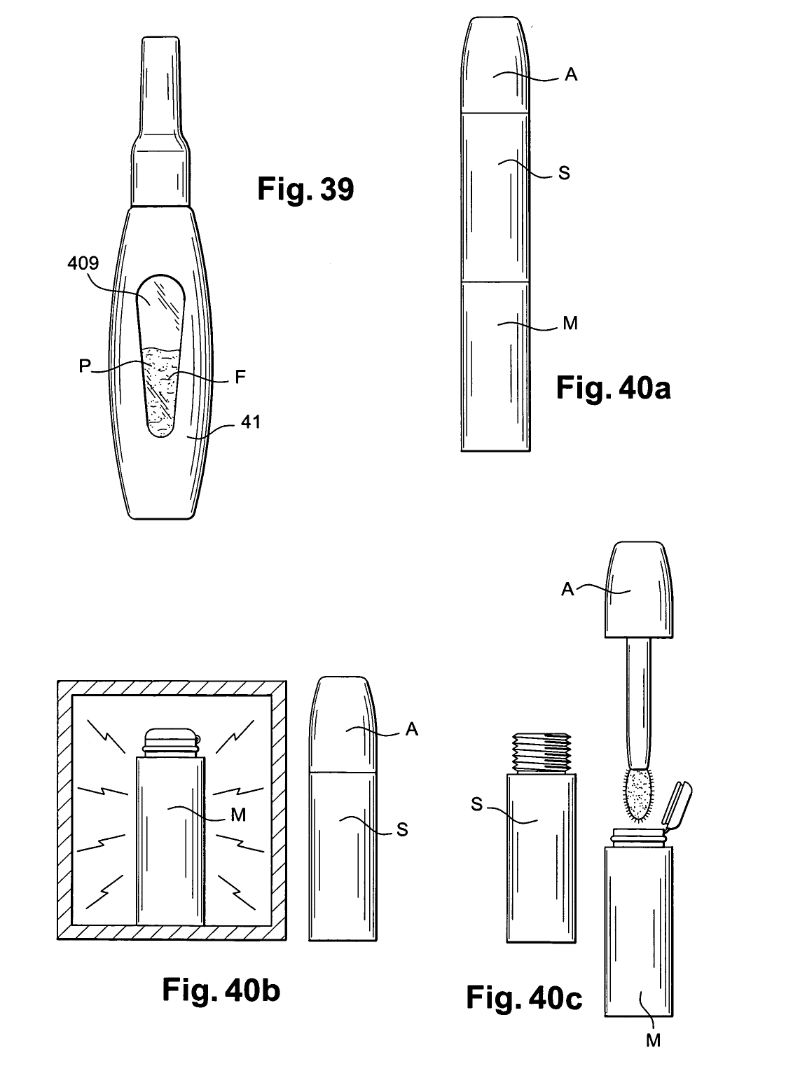

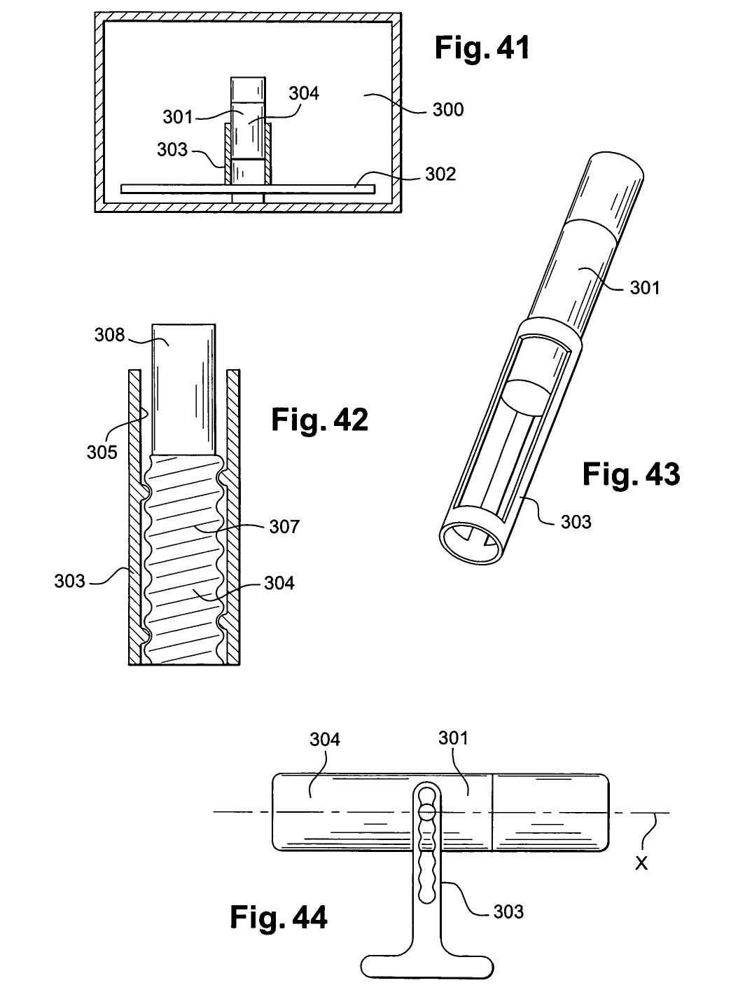

FIGS. 29-44 show other embodiments of the container, the indicator, and the applicator according to other embodiments of the invention, as discussed above.

Clearly, the invention is not limited to the examples described above. In particular, different features of the various embodiments can be combined between each other.

Throughout the description, including the claims, the expression “including a” should be understood to be synonymous with “including at least one”, unless otherwise specified.

Obviously, numerous modifications and variations of the present invention are possible in light of the above teachings. It is therefore to be understood that within the scope of the appended claims, the invention may be practiced otherwise than as specifically described herein.

1. A process for applying a cosmetic product, said process comprising:
placing a packaging device in a microwave oven, said cosmetic product being in said packaging device;
raising the temperature of said cosmetic product by exposing said cosmetic product to microwave radiation inside the microwave oven; and
applying the cosmetic product with an applicator.

2. The process according to claim 1, wherein said cosmetic product comprises particles of elongated shape.

3. The process according to claim 1, wherein said step of applying said cosmetic product is performed on keratinic fibers.

4. The process according to claim 1, wherein said cosmetic product is a skin care product.

5. The process according to claim 2, wherein said particles of elongated shape are fibers.

6. The process according to claim 1, wherein the packaging device includes the applicator and a container holding the product, and the method further comprises a step of detaching the applicator from the container before exposing said cosmetic product to said microwave radiation.

7. The process according to claim 1, further comprising keeping the applicator out of the microwave oven during exposing the cosmetic product to said microwave radiation.

8. The process according to claim 1, further comprising placing the applicator in the microwave oven and exposing the applicator to microwave radiation in order to raise its temperature at an application surface.

9. The process according to claim 1, wherein the product is applicable hot after heating, and applicable at ambient temperature without heating.

10. The process according to claim 1, wherein said step of raising said temperature is performed so as to raise said temperature between 30° C. and 80° C.

11. The process according to claim 1, wherein the step of exposing said cosmetic product to said microwave radiation has a duration between 1 and 60 seconds.

12. The process according to claim 11, wherein said step of exposing said cosmetic product to said microwave radiation has a duration between 2 and 50 seconds.

13. The process according to claim 11, wherein said step of exposing said cosmetic product to said microwave radiation has a duration between 3 and 25 seconds.

14. The process according to claim 1, wherein the step of placing the packaging device is performed by placing the packaging device in a recumbent position, wherein a height of the cosmetic product relative to a surface on which the packaging device is placed is lower than a height of the cosmetic product when the packaging device is presented relative to said surface in a usage position.

15. A packaging device comprising:
an applicator; and
a container holding a cosmetic product incorporating particles of elongated shape, wherein said container is capable of being heated in a microwave oven with microwave radiation.

16. A device according to claim 15, wherein the particles are dispersed in a composition for coating keratinic fibers.

17. The device according to claim 15, further comprising an indicator sensitive to the temperature of the cosmetic product.

18. The device according to claim 17, wherein the indicator is integral with the container holding the product.

19. The device according to claim 17, wherein the indicator is integral with the applicator at least when the device is placed in the microwave oven.

20. The device according to claim 17, further comprising a closure element coupled to the container; and wherein the indicator is integral with the closure element at least when the packaging device is placed in the microwave oven.

21. The device according to claim 17, wherein the indicator changes color according to temperature.

22. The device according to claim 17, wherein the indicator changes appearance in a reversible manner according to temperature.

23. The device according to claim 17, wherein the indicator changes state at a first temperature lower than a second temperature to which the product is to be heated.

24. The device according to claim 17, wherein the indicator includes at least one flexible support fixed on the packaging device.

25. The device according to claim 17, wherein the indicator comprises a printed ink incorporating a thermochromic pigment.

26. The device according to claim 17, wherein the indicator comprises a thermochromic pigment incorporated into a part of the packaging device.

27. The device according to claim 17, wherein the container has a variable thickness, and the indicator covers at least two regions of dissimilar thickness of the container.

28. The device according to claim 15, further comprising two indicators, each indicator having a different transition temperature.

29. The device according to claim 15, further comprising a closure element for the container.

30. The device according to claim 15, wherein the container is permeable to microwave radiation.

31. The device according to claim 15, further comprising a reference mark indicating a position in which the container is to be placed in the microwave oven.

32. The device according to claim 15, further comprising a wall arranged for placing the container in a recumbent position.

33. The device according to claim 32, wherein said wall has a prismatic transverse cross-section with at least one flat surface.

34. The device according to claim 15, further comprising a notice informing a user that the container can be placed in a microwave oven.

35. The device according to claim 15, further comprising an anti-splash element to reduce expulsion of the cosmetic product when the container is opened.

36. The device according to claim 15, further comprising a flow-reducing element to reduce a loss of cosmetic product when the container is overturned.

37. The device according to claim 15, wherein the product held in the container is liquid at ambient temperature.

38. The device according to claim 15, wherein said container is devoid of metal.

39. The device according to claim 15, wherein the container includes a wall made at least partially of a first material, and further comprising a thermal insulator that surrounds at least partially an external surface of the container.

40. The device according to claim 39, wherein the thermal insulator is made of a second material having a lower thermal conductivity than that of the first material.

41. The device according to claim 15, further comprising a safety valve arranged to open in case of excess pressure in the container.

42. The device according to claim 15, further comprising a stand capable of placing the container higher relative to a surface on which the stand is placed.

43. The device according to claim 42, wherein the stand includes a temperature indicator.

44. A device comprising:
a container with a cosmetic product incorporating particles; and
an applicator for applying said cosmetic product on a surface,
wherein, when said cosmetic product is exposed to microwave radiation, said cosmetic product fluidizes locally around said particles such that said particles are oriented relative to said surface when said cosmetic product is applied with said applicator.

45. The device according to claim 44, further comprising an indicator that changes appearance with changes in temperature.

46. The device according to claim 45, wherein said indicator indicates that said cosmetic product is above a first temperature and below a second temperature.

47. The device according to claim 46, wherein said first temperature is 30° C. and said second temperature is 50° C.

48. A device comprising:
a container with a cosmetic product incorporating particles of elongated shape; and
an applicator to apply said cosmetic product,
wherein said container is permeable to microwave radiation and said cosmetic product in said container is heated when said container is placed in a microwave oven that radiates microwave radiation.

49. The device according to claim 48, further comprising an indicator that changes appearance with changes in temperature.

50. The device according to claim 49, wherein said indicator indicates that said cosmetic product is above a first temperature and below a second temperature.

51. The device according to claim 50, wherein said first temperature is 30° C. and said second temperature is 50° C.
